(19) United States
(12) Patent Application Publication
(10) Pub. No.: US 2004/0078161 A1
(43) Pub. Date: Apr. 22, 2004

(54) Method and system for processing failed material claims

(75) Inventors: Michael F. Hansen, Palos Heights, IL (US); Richard Allen Myles, Lockport, IL (US); Loriann Riccetti, Arlington Heights, IL (US); Michael R. Saeger, Medinah, IL (US)

Correspondence Address: Brinks Hofer Gilson & Lione, P.O. Box 10395, Chicago, IL, 60610, US

(73) Assignee: TTX Company

(21) Appl. No.: 10/271,506

(22) Filed: Oct. 16, 2002

(51) Int. Cl. G06F 17/60; G06F 19/00; G01N 37/00

(52) U.S. Cl. 702/84; 705/4; 705/1

(57) ABSTRACT

A method and system for processing a claim for a failed material supplied by a material supplier to an equipment owner, wherein the failed material is received by a claim initiator on behalf of the equipment owner. The claim initiator is provided with access to an automated claim system, which includes a database, via a claim initiator interface. A failed material claim report, which includes information related to the failed material, is received from the claim initiator via the claim initiator interface. A failed material claim record, which includes at least some of the information related to the failed material, is created in the database. An electronic message is generated to notify the equipment owner of the failed material claim report. An electronic message also is generated to notify the material supplier of the failed material claim report. The material supplier is then provided with access to the automated claim system via a supplier interface. The material supplier is enabled to review, via the supplier interface, at least some of the information related to the failed material. A claim response is then received from the material supplier via the supplier interface. An electronic message is then generated to notify the claim initiator of the claim response.

### BACKGROUND OF THE INVENTION

The present invention relates to the processing of failed material claims. In particular, this invention relates to methods and systems for facilitating communication between a claim initiator, an equipment owner, and a supplier regarding a failed material claim. Although it may be applicable to a wide variety of industries, the invention will be described with a particular emphasis on failed material claims in the railroad industry.

The railroad network in the United States includes a number of railroad systems that are owned by different companies. Together, these systems comprise a complete railroad network that connects locations across the nation. Although some railroad companies also own their own railcars, many railcars are owned by other companies that do not own any part of the railroad network itself. To move from one location to another, therefore, one company's railcars frequently need to travel over another company's railroad system. In addition, the company operating a railcar may not own the railcar. In that case, the railcar user hires the railcar from the railcar owner.

A failed material claim in the context of the railroad industry typically arises when a railcar part that is defective or covered by warranty fails during operation, or when the part is found to be defective in the process of applying it to a railcar. The defective part is referred to as a failed material. When a failed material is identified, a claim may be made against the supplier of the failed material. The failed material claim typically involves three parties. The first party is the claim initiator, which also may be known as the reporting company. The claim initiator usually is the party that identifies the failed material and begins the claim process. The claim initiator may be one of the numerous repair agents that perform railcar repairs at repair facilities located at various points on the railroad network. These repair facilities may be owned and operated by the railroad, the railcar owner, or by an independent repair agent. The claim initiator also may be a car builder or a distribution center.

The second party to a typical failed material claim is the contractor, or the original supplier of the failed material. As the original supplier of a defective part or a part covered by warranty, the contractor usually is responsible for repairing or replacing the part. For this reason, the failed material claim typically is submitted to the contractor.

The third party to a typical failed material claim is the equipment owner, which in the railroad industry typically is the railcar owner. Because many of the railcar repair facilities in the United States are owned and operated by parties other than the railcar owner, the railcar owner typically is not in direct control of the repair. However, the railcar owner usually is notified of the failed material claim. One reason for notifying the railcar owner of the failed material claim is that the railcar owner may wish to approve the failed material claim before it is submitted to the supplier.

Traditionally, the submission and processing of failed material claims has been slow and paper-intensive. For instance, in the railroad industry, this process is governed by the Association of American Railroads (“AAR”) Specification for Quality Assurance. In particular, Chapter 7 of the AAR Specification for Quality Assurance governs Quality Assurance Nonconformance Reporting for failed materials governed by M-1003. For each failed material governed by M-1003, the AAR Specification requires completion of a Quality Assurance Nonconformance Report, also known as form QA-7.1, and a Quality Assurance Nonconformance Response Report, also known as form QA-7.2.

According to the AAR Specification, the claim initiator completes form QA-7.1 and sends the completed form to the supplier of the failed material. Typically, however, the form is sent to the railcar owner first to notify the railcar owner of the failed material claim and to allow the railcar owner to supply additional information. For instance, the claim initiator may not know the identity of the failed material supplier. In this case, the railcar owner usually completes certain portions of the QA-7.1 form that relate to the failed material supplier.

Form QA-7.2, according to the AAR Specification, is used by the failed material supplier to notify the railcar owner and the claim initiator of the disposition of the failed material. For instance, the supplier may indicate what was done to provide the claim initiator with conforming material to replace the failed material. The supplier also may indicate what corrective action was taken to avoid similar material failures in the future.

The slow physical exchange of QA-7.1 and QA-7.2 forms according to traditional methods has caused numerous problems. For instance, in the traditional processing of failed material claims it has been difficult to track each claim throughout the process. Because hardcopy forms QA-7.1 and QA-7.2 have been exchanged between the parties, it has been difficult for each party to accurately track progress of the process. Accordingly, it has been difficult to determine when a form has been unnecessarily delayed in the reporting process, or even if the reporting form itself has been lost. Because of these problems, the processing of failed material claims has been complicated, time-intensive, and expensive for all parties involved.

It is, therefore, an object of the present invention to provide an improved, centralized, and standardized method and apparatus for processing failed material claims. It is another object of the present invention to provide a method and apparatus that allows for efficient electronic submission, tracking, and resolution of failed material claims. It is a still further object of the present invention to provide a method and apparatus for processing failed material claims that complies with the AAR Quality Assurance Specification.

### BRIEF SUMMARY OF THE PREFERRED EMBODIMENTS

In accordance with the present invention, a method and system are described for failed material claims between a claim initiator, an equipment owner, and a supplier.

According to one aspect of the present invention, there is provided a method of processing a claim for a failed material supplied by a material supplier to an equipment owner, wherein the failed material is received by a claim initiator on behalf of the equipment owner. The claim initiator is provided with access to an automated claim system, which includes a database, via a claim initiator interface. A failed material claim report, which includes information related to the failed material, is received from the claim initiator via the claim initiator interface. A failed material claim record, which includes at least some of the information related to the failed material, is created in the database. An electronic message is generated to notify the equipment owner of the failed material claim report. An electronic message also is generated to notify the material supplier of the failed material claim report. The material supplier is then provided with access to the automated claim system via a supplier interface. The material supplier is enabled to review, via the supplier interface, at least some of the information related to the failed material. A claim response is then received from the material supplier via the supplier interface. An electronic message is then generated to notify the claim initiator of the claim response.

According to another aspect of the present invention, an automated system is provided for processing a claim for a failed material supplied by a material supplier to an equipment owner, wherein the failed material is received by a claim initiator on behalf of the equipment owner. A database is provided that includes a plurality of failed material claim records. Means are provided for providing the claim initiator with access to the system to create, modify, and review the failed material claim records. Means also are provided for providing the equipment owner with access to the system to review the failed material claim records. Means also are provided for providing the material supplier with access to the system to review and modify the failed material claim records. A messaging server is provided that is operable to generated electronic messages. A processing unit is provided that is programmable to receive a failed material claim report from the claim initiator, create a new failed material claim record and store the record in the database, instruct the messaging server to generate a message to the equipment owner; instruct the messaging server to generate a message to the material supplier, receive a claim response from the material supplier, and instruct the messaging server to generate a message to the claim initiator.

The invention, and its objects and advantages, will become more apparent in the detailed description of the preferred embodiment presented below.

### BRIEF DESCRIPTION OF THE DRAWINGS

The subsequent description of the preferred embodiments of the present invention refers to the attached drawings, wherein:

FIG. 1 shows a block diagram illustrating an automated failed material processing system according to one presently preferred embodiment of the invention;

FIG. 2 shows a flow diagram depicting a method of processing failed material claims according to another presently preferred embodiment of the invention;

FIG. 3 shows a flow diagram illustrating a method of processing failed material claims relating to failed railcar components according to another presently preferred embodiment of the invention;

FIG. 4 shows a flow diagram illustrating a method of processing failed material claims from the perspective of a claim initiator according to another presently preferred embodiment of the invention;

FIG. 5 shows a screen display of a failed material claim report form web page from a claim initiator graphical user interface according to another presently preferred embodiment of the invention;

FIG. 6 shows a flow diagram illustrating a method of processing failed material claims from the perspective of an equipment owner according to another presently preferred embodiment of the invention;

FIG. 7 shows a screen display of a railcar owner section of a failed material claim report form web page from an equipment owner graphical user interface according to another presently preferred embodiment of the invention;

FIG. 8 shows a flow diagram illustrating a method of processing failed material claims from the perspective of a supplier of a failed material according to another presently preferred embodiment of the invention;

FIG. 9 shows a screen display of a failed material claim response form web page from a material supplier graphical user interface according to another presently preferred embodiment of the invention; and

FIG. 10 shows a screen display of a failed material claim corrective action form web page from a material supplier graphical user interface according to another presently preferred embodiment of the invention.

### DETAILED DESCRIPTION OF THE PREFERRED EMBODIMENTS

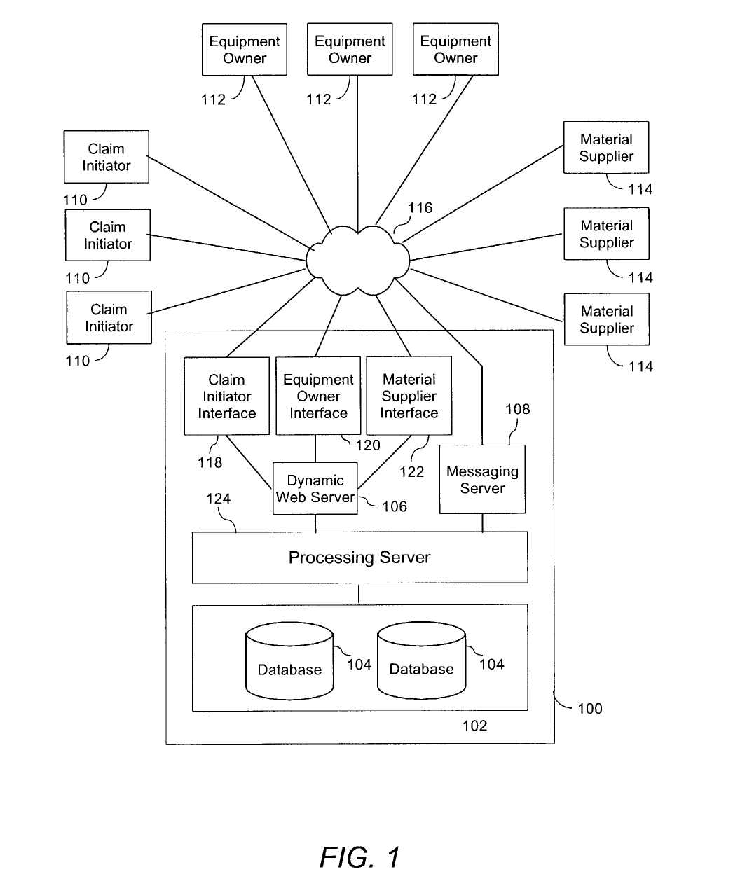

Referring now to the accompanying drawings, FIG. 1 shows a block diagram illustrating an automated failed material processing system 100 according to one presently preferred embodiment of the invention. The system 100 may be used to track and process a failed material claim (“FMC”), and is useful for claim initiators 110, equipment owners 112, and material suppliers 114 from a wide variety of industries. For example, in the context of the railroad industry, an equipment owner 112 may be the owner of a railcar. In this case, the claim initiator 110 may be, among other entities, a car builder, a railcar material distributor, or the operator of a repair facility at a location along the railroad network. The material supplier 114 may be the supplier of a failed railcar part or material.

The automated failed material processing system 100 of this embodiment includes a database server 102 on which one or more databases 104 reside. The databases 104 store failed material claim records for each failed material claim processed by the system 100. The databases 104 also may contain records pertaining to the identity and location of a number of claim initiators 110, equipment owners 112, and material suppliers 114. The system 100 also includes a dynamic web server 106 that is in communication with the database server 102 and is capable of generating customized web pages using data from the databases 104. One or more interfaces provide access to the web pages generated by the dynamic web server 106. For instance, the system 100 may include a claim initiator graphical user interface 118 through which claim initiators 110 may access the system 100. Using the claim initiator graphical user interface 118, a claim initiator 110 may submit new failed material claim reports and review records for pending failed material claims. Similarly, the system 100 may include an equipment owner graphical user interface 120. Using the equipment owner graphical user interface 120, an equipment owner 112 may access the system 100 to review and modify failed material claim records. A supplier graphical user interface 122 also may be provided. Using the supplier graphical user interface 122, a supplier 114 of a failed material may access the system 100 to review the failed material claim record and provide instructions for processing the failed material. Preferably, claim initiators 110, equipment owners 112, and material suppliers 114 access the various graphical user interfaces 118, 120, 122 via a secure distributed computer network 116 such as an intranet, a virtual private network, or a secure Internet connection.

The system 100 also includes a messaging server 108, such as an SMTP email server, that is in communication with the database server 102 and capable of generating messages to claim initiators 110, equipment owners 112, and material suppliers 114. The messaging server preferably sends messages via the secure distributed network 116.

A processing server 124 preferably controls operation of the system 100. For instance, the processing server 124 may be a processing unit such as a mainframe computer, a personal computer, or a microprocessor. Instructions from suitable programming code operating on the processing server 124 may be used to direct the various components to operate according to the methods described below. The programming code may be created according to methods known in the art using known programming languages such as Java.

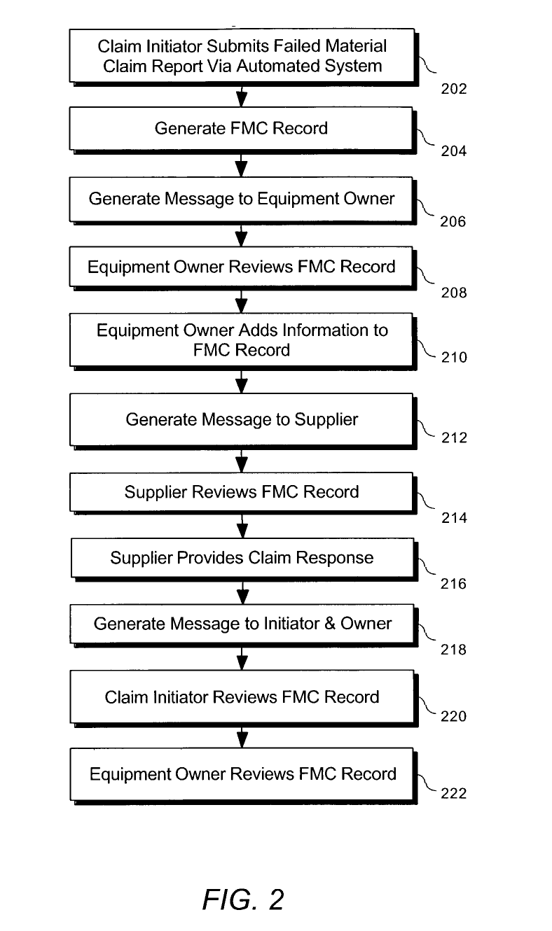

Various methods of processing failed material claims according to the invention will now be described with reference to FIGS. 2-9. For instance, FIG. 2 shows a flow diagram depicting a method of processing failed material claims according to another presently preferred embodiment of the invention. The method depicted in FIG. 2 is applicable to a wide variety of industries involving claim initiators 110, equipment owners 112, and material suppliers 114. The method begins when a claim initiator 110 accesses an automated failed material claim processing system 100 and submits a new failed material report in step 202. The claim initiator 110 preferably accesses the automated system 100 using a claim initiator graphical user interface 118 via a secure distributed computer network 116. An authentication scheme preferably is used to control access to the automated system 100 and to authenticate the identity of the claim initiator 110. By completing a failed material claim report form provided via the claim initiator interface 118, the claim initiator 110 provides information related to the failed material. The information may include the name of the equipment owner 112 that owns the equipment at issue, a description or other identifying information relating to the equipment, the name of the manufacturer or material supplier that is responsible for the quality of the failed material, the quantity of failed materials, the part number(s), the serial number(s), and a description of the failure.

After the claim initiator 110 has submitted the failed material report, the automated system 100 generates a failed material claim record in step 204 and stores the record in a database 104. The record preferably includes all of the failed material information provided by the claim initiator 110. The system preferably then notifies the appropriate equipment owner 112 of the new failed material claim report in step 206 by generating an electronic message to the equipment owner. The electronic message preferably is an email message automatically generated by an SMTP server. Optionally, the equipment owner 112 may then access the automated system 100 in step 208 to review information in the failed material claim record. If necessary, the equipment owner 112 also may submit additional information relating to the failed material in step 210. For instance, the equipment owner 112 may provide the price per item of the failed material, as well as the proper contact information for the material supplier 114. If additional information is provided by the equipment owner 112, the system 100 adds that information to the failed material claim record.

The system 100 then notifies the appropriate material supplier 114 of the failed material claim report in step 212 by generating an electronic message to the supplier. The supplier 114 then accesses the system 100 in step 214 to review information in the failed material claim record. In step 216, the supplier 114 submits a claim response via the automated system 100. The claim response includes instructions for disposition of the failed material. Typically, the failed material will be returned to the supplier for inspection. In this case, the claim response includes a return authorization and shipping instructions. Information from the claim response is then added to the failed material claim record.

After the material supplier 114 has provided a claim response, the automated system 100 notifies the proper claim initiator 110 of the claim response in step 218 by generating an electronic message to the claim initiator 110. Optionally, the automated system also may generate a similar electronic message to the equipment owner in step 218. After receiving these electronic messages, the claim initiator 110 and the equipment owner 112 may access the automated system via their respective interfaces 118, 120 to review the supplier's claim response, as shown in steps 220 and 222. The claim initiator 110 may then follow the supplier's instructions to return or otherwise properly dispose of the failed material. This notification also enables the claim initiator 110 and the equipment owner 112 to adjust any necessary inventory and/or accounting systems to account for return or other disposition of the failed material.

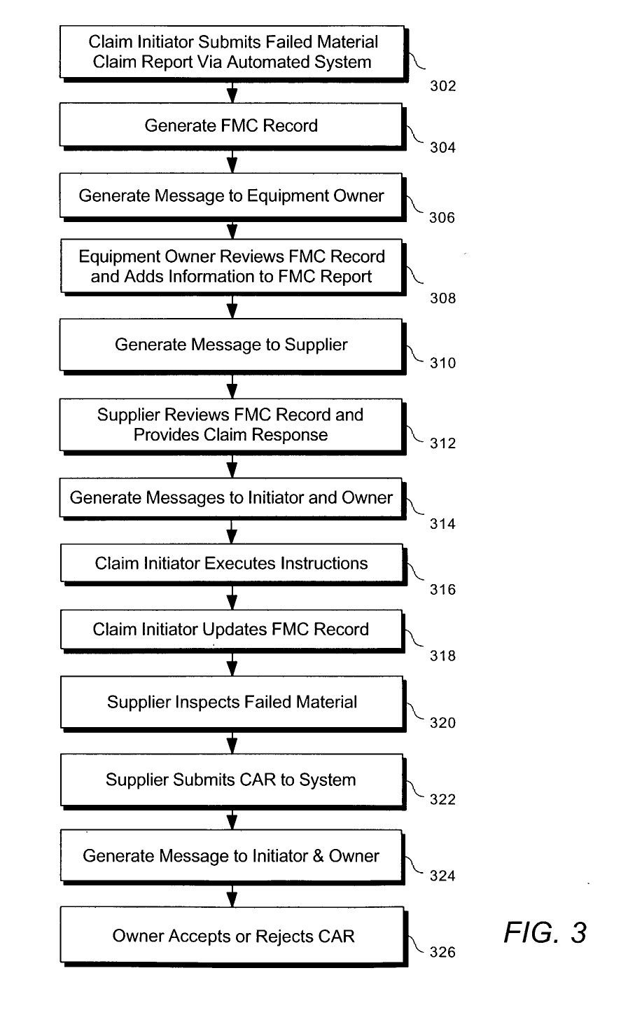

Turning to the railroad industry in particular, FIG. 3 shows a flow diagram illustrating a method of processing failed material claims relating to failed railcar components according to another presently preferred embodiment of the invention. In the context of the railroad industry, the equipment owner 112 typically is a railcar owner, and the claim initiator typically is a repair agent, railcar builder, or material distribution center. The process begins with the claim initiator 110 accessing the automated system 100 via a claim initiator interface 118 in step 302 and submitting a failed material claim report including information relating to the failed material. The information provided by the claim initiator 110 may include some or all of the following: name of the railcar owner, identification number of the railcar, name of the manufacturer or supplier of the failed material, quantity of the failed material, part number(s) and serial numbers(s) of the failed material, and description of the failure. In step 304, the automated system 100 generates a failed material claim record that includes at least some, and preferably all, of the information provided by the repair agent. The automated system 100 stores the failed material claim record in the database 104. The automated system 100 preferably then generates an electronic message in step 306 to notify the proper railcar owner 112 of the new failed material claim report. The railcar owner 112 preferably then accesses the automated system 100 via an equipment owner interface 120 in step 308 to review some or all of the information in the failed material claim record. The railcar owner 112 also may add information to the failed material claim record. For instance, the railcar owner 112 may add the price of the failed material, the contact information for the supplier of the failed material, and/or the location of the regional distribution center that through which the material was distributed.

After updating the failed material claim record with any new information provided by the railcar owner 112, the automated system 100 generates an electronic message in step 310 to notify the proper material supplier 114 of the failed material claim. The supplier 114 then accesses the automated system via a supplier interface 122 in step 312. By accessing the automated system 100, the supplier 114 is able to review at least some of the information in the failed material claim record and to provide a claim response. The claim response preferably includes instructions to the claim initiator 110 for the proper disposition of the failed material. For instance, the claim response typically includes a return authorization and return shipping instructions.

After the material supplier 114 submits a claim response, the automated system generates an electronic message in step 314 to notify the claim initiator 110 and the railcar owner 112 that the claim response has been submitted. The claim initiator 110 then accesses the automated system 100 via the claim initiator interface 118 in step 316 to review the claim response. The claim initiator 110 then disposes of the failed material according to the supplier's instructions in the claim response. Typically, this means that the claim initiator 110 returns the failed material to the supplier 114 according to the supplier's return shipping instructions. The claim initiator 110 then updates the failed material claim record via the claim initiator interface 118 in step 318 to confirm execution of the supplier's claim response instructions. If the instructions called for return of the failed material to the supplier 114, the claim initiator 110 adds return shipping information, such as a shipping confirmation number, to the failed material claim record.

In step 320, if the supplier 114 requested that the failed material be returned, then upon receipt the supplier 114 inspects the failed material and takes any necessary corrective action. The corrective action may include adjusting manufacturing procedures to decrease the likelihood that materials will fail in the same manner in the future. The supplier 114 then accesses the automated system 100 again via the supplier interface 122 in step 322 to update the failed material claim record with a corrective action response (“CAR”). The corrective action response describes the corrective action taken by the supplier 114.

After the supplier 114 has submitted the corrective action response, the automated system 100 generates a message in step 324 to notify the claim initiator 110 and the railcar owner 112 that the corrective action response has been submitted. The claim initiator 110 and/or the railcar owner 112 may then access the automated system 100 via their respective interfaces 118, 120 in step 326 to review the corrective action response. Based on their review, and pursuant to the AAR Specification, the claim initiator 110 and/or the railcar owner 112 may accept or reject the supplier's corrective action. If the corrective action is accepted, the automated system 100 updates the failed material claim record to indicate that the failed material claim is closed. If the corrective action is rejected, the automated system 100 may generate an electronic message to notify the supplier 114 of the rejection. The supplier 114 may then change the corrective action response. This process may be repeated until the claim initiator 110 and/or the railcar owner 112 are satisfied with the supplier's corrective action. Alternatively, the automated system 100 may generate an electronic message to notify the railcar owner 112 of the rejection. The railcar owner 112 then may contact the supplier 114 outside of the automated system 100 to negotiate an acceptable corrective action.

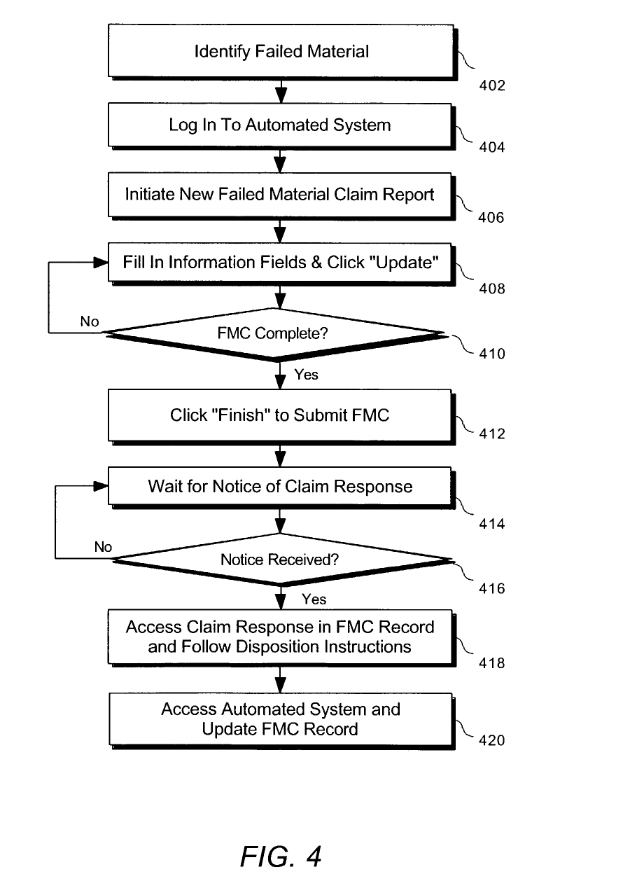

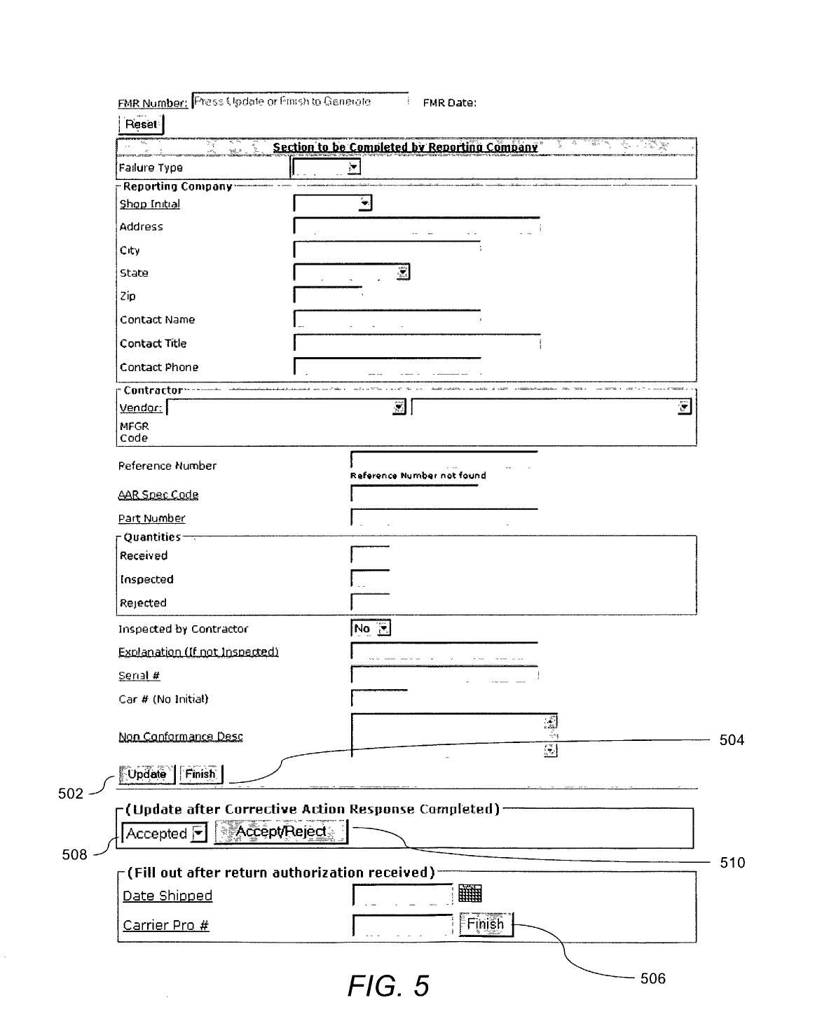

A method of processing failed material claims will now be described from the perspective of a claim initiator 110. FIG. 4 shows a flow diagram illustrating a method of processing failed material claims from the perspective of a claim initiator 110 according to another presently preferred embodiment of the invention. The claim initiator 110 first identifies a failed material in step 402. The claim initiator 110 then accesses the automated claim processing system 100 in step 404 by logging in via a secure authentication scheme. In step 406, the claim initiator 110 initiates a new failed material claim report via the claim initiator interface 118. The automated system 100 then presents the claim initiator 110 with a failed material claim report form web page such as the one shown in FIG. 5. In step 408, the claim initiator 110 supplies information for at least some of the fields in the claim report form web page and uses an electronic pointing device, such as a computer mouse, to click the “Update” button 502. The claim initiator then determines whether the failed material claim report is complete in step 410. If the form is complete, the claim initiator 110 clicks the “Finish” button 504 to submit the claim report in step 412. If the form is not complete, the claim initiator 110 may return to step 408 at a later time to supply additional information before submitting the claim report. Once the “Finish” button 504 is clicked, the failed material claim report preferably is locked and the claim initiator 110 is prohibited from making further changes to the information in the report form.

After submitting the failed material claim report in step 412, the claim initiator 110 waits for notification of the supplier's claim response in steps 414 and 416. Once the claim initiator 110 receives notification of the supplier's claim response, preferably in the form of an electronic message from the automated system 100, the claim initiator 110 accesses the automated system 100 to review the claim response and then follows the supplier's disposition instructions with respect to the failed material in step 418. The claim initiator 110 then updates the failed material claim report in step 420 with confirmation that the supplier's instructions were executed by completing the confirmation section of the failed material claim report form shown in FIG. 5 and clicking the “Finish” button 506. If the instructions required return of the failed material to the supplier 114, the claim initiator 110 includes a shipping confirmation number in the confirmation.

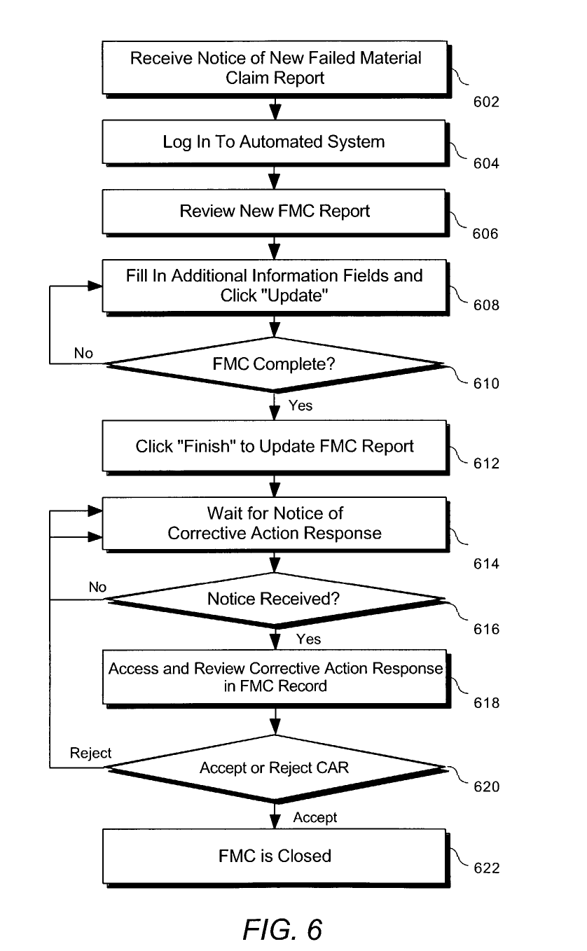

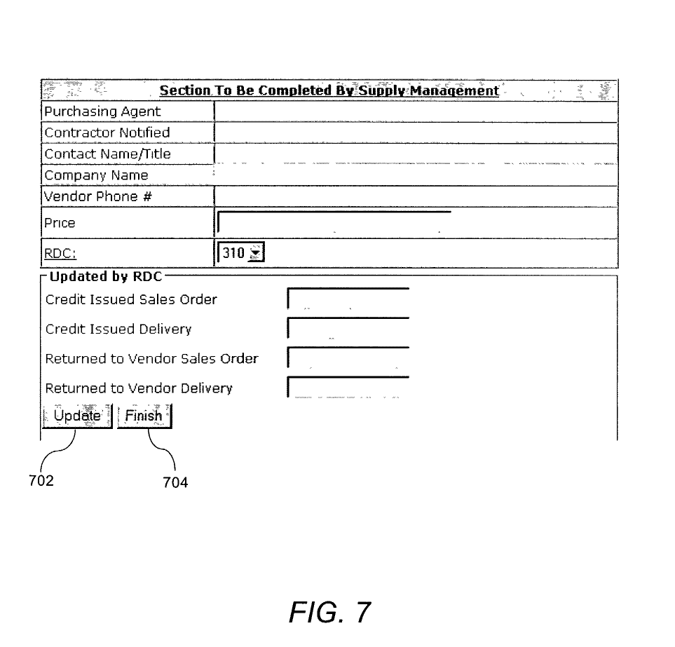

A method of processing failed material claims will now be described from the perspective of a railcar owner 112. FIG. 6 shows a flow diagram illustrating a method of processing failed material claims from the perspective of a railcar owner 112 according to another presently preferred embodiment of the invention. The railcar owner 112 first receives notification of a new failed material claim report in step 602. The railcar owner 112 preferably then accesses the automated claim processing system 100 in step 604 by logging in via a secure authentication scheme. In step 606, the railcar owner reviews the new failed material claim report via the equipment owner interface 120. The automated system 100 presents the railcar owner 112, via the equipment owner interface 120, with a railcar owner section of the failed material claim report form web page such as the one shown in FIG. 7. If necessary, in step 608, the railcar owner 112 supplies information for some of the fields in the claim report form web page and uses an electronic pointing device, such as a computer mouse, to click the “Update” button 702. The railcar owner 112 then determines whether the updated failed material claim report form is complete in step 610. If the form is complete, the railcar owner 112 clicks the “Finish” button 704 to submit the updated failed material claim report in step 612. Any information provided by the railcar owner 112 is then added to the failed material claim record in the database 104. If the form is not complete, the railcar owner 112 may return to step 608 at a later time to supply additional information before submitting the claim report. Once the “Finish” button 704 is clicked, the updated failed material claim report preferably is locked and the railcar owner 112 is prohibited from making further changes to the information in the report form.

After submitting the updated failed material claim report in step 612, the railcar owner 112 waits for notification that the material supplier 114 has submitted a corrective action response in steps 614 and 616. Once the railcar owner 112 receives notification of the supplier's corrective action response, preferably in the form of an electronic message from the automated system 100, the railcar owner 112 accesses the automated system 100 to review the corrective action response in step 618. The railcar owner 112 may then accept or reject the corrective action response in steps 620 or 622 by accessing the failed material claim report form shown in FIG. 5 and selecting “Accept” or “Reject” from the drop-down list 508 and then clicking on the “Accept/Reject” button 510. If the railcar owner 112 rejects the corrective action response, the method returns to step 614 to wait for notification of an updated corrective action response from the supplier 114. Alternatively, the railcar owner 112 may contact the material supplier 114 outside of the automated system 100 to negotiate an acceptable corrective action.

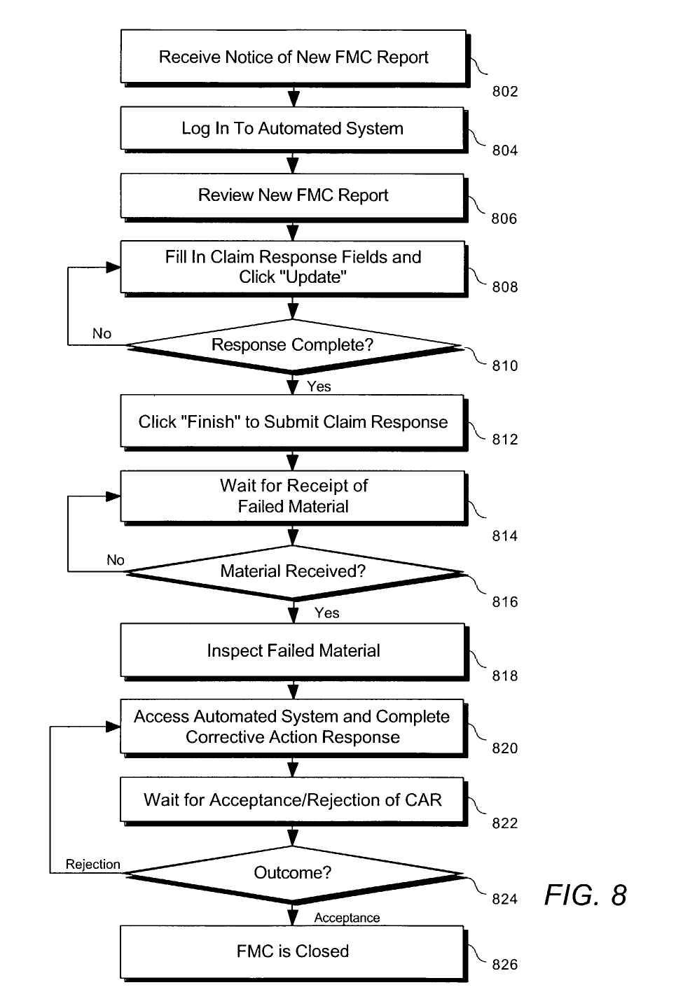

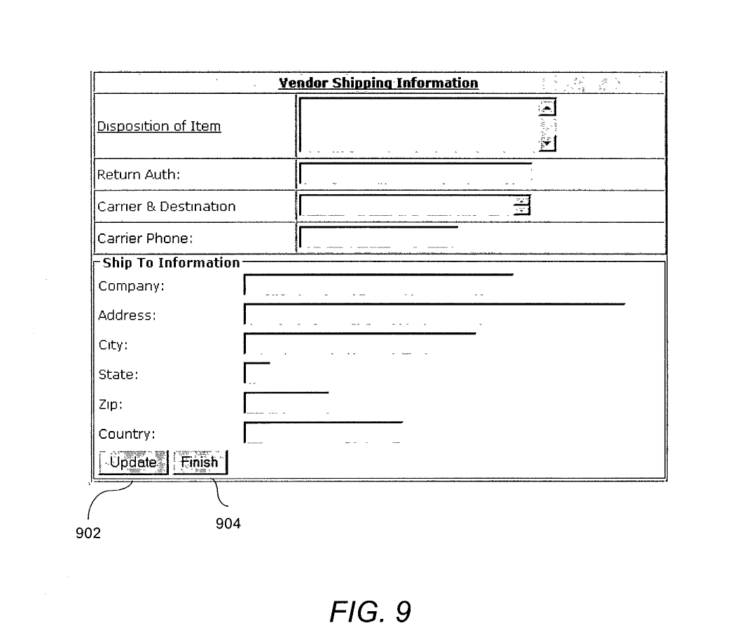

A method of processing failed material claims will now be described from the perspective of a material supplier 114. FIG. 8 shows a flow diagram illustrating a method of processing failed material claims from the perspective of a material supplier 114 according to another presently preferred embodiment of the invention. The material supplier 114 first receives notification of a new failed material claim report in step 802. The material supplier 114 then accesses the automated claim processing system 100 in step 804 by logging in via a secure authentication scheme. In step 806, the material supplier 114 reviews the new failed material claim report via the material supplier interface 122. The automated system 100 then presents the supplier 114 with a material supplier claim report form web page such as the one shown in FIG. 9. In step 808, the material supplier 114 supplies information for at least some of the fields in the material supplier claim report form web page and uses an electronic pointing device, such as a computer mouse, to click the “Update” button 902. The material supplier 114 then determines whether the material supplier claim report form is complete in step 810. If the form is complete, the material supplier 114 clicks the “Finish” button 904 to submit the material supplier claim response in step 812. The information provided by the material supplier 114 is then added to the failed material claim record in the database 104. If the form is not complete, the material supplier 114 may return to step 808 at a later time to supply additional information before submitting the claim response. Once the “Finish” button 904 is clicked, the material supplier claim response preferably is locked and the material supplier 114 is prohibited from making further changes to the information in the response form.

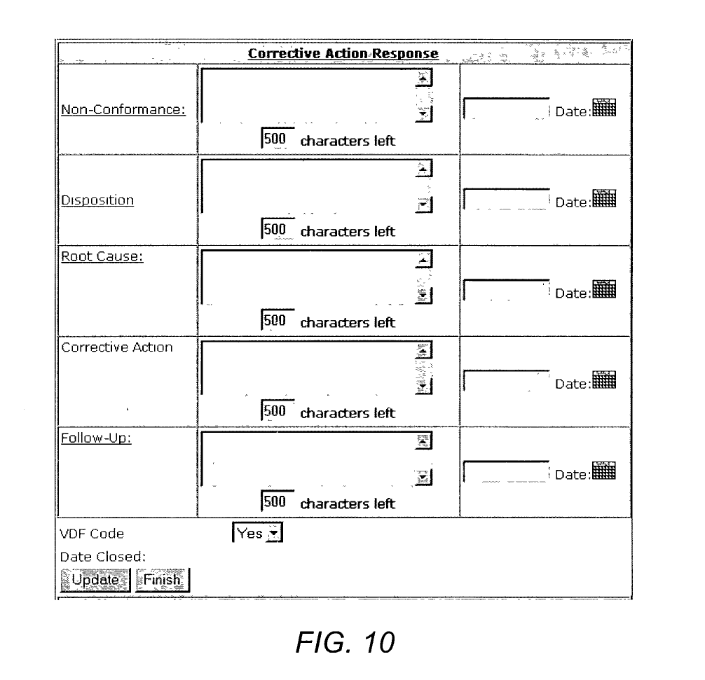

After submitting the claim response in step 812, the material supplier 114 waits for the claim initiator 110 to return the failed material or for confirmation that the claim initiator 110 has disposed of the failed material according to the supplier's instruction in steps 814 and 816. Again, the supplier's instructions typically require return of the failed material to the supplier 114. Therefore, upon receipt of the failed material, the supplier 114 inspects the material in step 818. The material supplier 114 then accesses the automated system 100 again in step 820 to submit a corrective action response using a form such as the one shown in FIG. 10. After submitting the corrective action response, the material supplier 114 waits in steps 822 and 824 for notification that the railcar owner 110 has accepted or rejected the corrective action response. If the corrective action response is accepted, the material supplier's role in the claim process is complete. If the material supplier determines in step 824, however, that the corrective action response was rejected, the supplier 114 may submit an updated corrective action response in step 820. The supplier 114 then returns to step 822 to wait for notification that the railcar owner 112 has accepted or rejected the updated corrective action response. Alternatively, the railcar owner 112 and the material supplier 114 may negotiate an acceptable corrective action outside the automatic system 100.

The invention has been described in detail with particular reference to preferred embodiments thereof and illustrative examples, but it will be understood that variations and modifications can be effected within the spirit and scope of the invention.

1. A method of processing a claim for a failed material supplied by a material supplier to an equipment owner, wherein the failed material is received by a claim initiator on behalf of the equipment owner, the method comprising:
providing the claim initiator with access to an automated claim system via a claim initiator interface, wherein said automated claim system includes a database;
receiving a failed material claim report from the claim initiator via the claim initiator interface, wherein the failed material report includes information related to the failed material;
creating a failed material claim record in the database, wherein the failed material claim record includes at least some of the information related to the failed material;
generating a first electronic message to notify the equipment owner of the failed material claim report;
generating a second electronic message to notify the material supplier of the failed material claim report;
providing the material supplier with access to the automated claim system via a supplier interface;
enabling the material supplier to review, via the supplier interface, at least some of the information related to the failed material;
receiving a claim response from the material supplier via the supplier interface;
generating a third electronic message to notify the claim initiator of the claim response.

2. A method of processing a claim for a failed material as in claim 1, wherein:
the automated claim system further includes a messaging server capable of generating the first, second, and third electronic messages.

3. A method of processing a claim for a failed material as in claim 1, wherein:
the first, second, and third electronic messages are email messages.

4. A method of processing a claim for a failed material as in claim 1, wherein:
the claim initiator interface includes one or more web page forms generated by a dynamic web server.

5. A method of processing a claim for a failed material as in claim 1, wherein:
the supplier interface includes one or more web page forms generated by a dynamic web server.

6. A method of processing a claim for a failed material as in claim 1, wherein:
information related to the failed material includes at least an identification of the material supplier and a serial number of the failed material.

7. A method of processing a claim for a failed material as in claim 1, wherein:
the claim response includes a return authorization and shipping instructions.

8. A method of processing a claim for a failed material as in claim 1, further comprising:
providing the equipment owner with access to the automated claim system via an owner interface;
enabling the equipment owner to review, via the owner interface, at least some of the information related to the failed material.

9. A method of processing a claim for a failed material as in claim 8, wherein:
the owner interface includes one or more web page forms generated by a dynamic web server.

10. A method of processing a claim for a failed material as in claim 8, further comprising:
receiving additional information related to the failed material from the equipment owner; and
updating the failed material claim record to include the additional information received from the equipment owner.

11. A method of processing a claim for a failed material as in claim 1, further comprising:
receiving a corrective action response from the material supplier, wherein the corrective action response includes corrective action information;
updating the failed material claim record to include at least some of the corrective action information; and
generating a fourth electronic message to the railcar owner notifying the railcar owner of the corrective action response.

12. An automated system for processing a claim for a failed material supplied by a material supplier to an equipment owner, wherein the failed material is received by a claim initiator on behalf of the equipment owner, the system comprising:
a database including a plurality of failed material claim records;
first means for providing the claim initiator with access to the system to create, modify, and review the failed material claim records;
second means for providing the equipment owner with access to the system to review the failed material claim records;
third means for providing the material supplier with access to the system to review and modify the failed material claim records;
a messaging server operable to generate electronic messages; and
a processing unit programmable to receive a failed material claim report from the claim initiator, wherein the failed material claim report includes information related to the failed material, create a new failed material claim record containing the information related to the failed material and store the record in the database, instruct the messaging server to generate a first message to the equipment owner; instruct the messaging server to generate a second message to the material supplier, receive a claim response from the material supplier, and instruct the messaging server to generate a third message to the claim initiator.

13. An automated system for processing a claim for a failed material as in claim 12, wherein:
the first means includes a claim initiator interface;
the second means includes an equipment owner interface; and
the third means includes a material supplier interface.

14. An automated system for processing a claim for a failed material as in claim 12, wherein:
the processing unit is further programmable to receive a corrective action response from the material supplier, wherein the corrective action response includes corrective action information, update the failed material claim record to include at lest some of the corrective action information; and instruct the messaging server to generate a fourth electronic message to the railcar owner notifying the railcar owner of the corrective action response.
